(19) United States
(12) Patent Application Publication
(10) Pub. No.: US 2022/0290882 A1
(43) Pub. Date: Sep. 15, 2022

(54) AIR PURIFIER

(71) Applicant: Shenzhen VanTop Technology & Innovation Co., Ltd., Shenzhen City (CN)

(72) Inventor: Mei Long, Shenzhen City (CN)

(73) Assignee: Shenzhen VanTop Technology & Innovation Co., Ltd., Shenzhen City (CN)

(21) Appl. No.: 17/337,631

(22) Filed: Jun. 3, 2021

(30) Foreign Application Priority Data
Mar. 15, 2021 (CN) 202120533168.4

(51) Int. Cl. F24F 8/158; B01D 46/10; F24F 13/20; B01D 46/00; F24F 13/28

(52) U.S. Cl. CPC F24F 8/158; B01D 46/103; F24F 13/20; B01D 46/0005; F24F 13/28

(57) ABSTRACT

Disclosed is an air purifier. The air purifier includes an outer housing assembly, an outer side filter element and an inner side filter element. The outer housing assembly defines a mounting cavity, and the outer housing assembly is provided with air inlet holes communicated with the mounting cavity. The outer side filter element is disposed in the mounting cavity. The inner side filter element includes a high efficiency particulate air (HEPA) layer and an activated carbon layer, and the inner side filter element is disposed on a radial inner side of the outer side filter element. The outer side filter element can be separately detached.

### CROSS-REFERENCE TO RELATED APPLICATION

This application claims priority to Chinese Patent Application No. 202120533168.4 filed Mar. 15, 2021, the disclosure of which is incorporated herein by reference in its entirety.

### TECHNICAL FIELD

The present disclosure relates to the technical field of air processing and, in particular, to an air purifier.

### BACKGROUND

A filter screen module of an air purifier is an integrated component. The filter screen module includes an outer-layer front filter screen, an inner-layer high efficiency particulate air

(HEPA) filter screen and an activated carbon filter screen. The front filter screen with big meshes is mainly used to filter relatively-large dust particles and hairs in air to protect other inner-layer filter screens. The HEPA filter screen is used to filter tiny particles, and the activated carbon filter screen is mainly used to adsorb peculiar smell and formaldehyde in the air. As long as the activated carbon filter screen is exposed to the sun regularly, the activated carbon filter screen can be used again after the formaldehyde volatilizes. Therefore, the front filter screen is easier to dirty than other layers of filter screens. However, all the filter screens are integrated, so that the cost for replacing the integrated filter screens is relatively high. In addition, if the outer-layer front filter screen is scrubbed by a wiping cloth or sucked by a dust collector, large-particle dirt is easily rubbed into the inner-layer HEPA filter screen, resulting in increased machine noise and reduced filtering effect.

### SUMMARY

The present disclosure aims to provide an air purifier. For the air purifier, an outer side filter screen with relatively large meshes can be detached for cleaning, so that it is not necessary to integrally replace a filter cartridge module. Therefore, the use cost of the air purifier is reduced, and the noise caused in the use process of the air purifier is simultaneously reduced.

To achieve the above effect, the present disclosure provides the solutions described below.

The present disclosure discloses an air purifier. The air purifier includes an outer housing assembly, an outer side filter element and an inner side filter element. The outer housing assembly defines a mounting cavity, and the outer housing assembly is provided with air inlet holes communicated with the mounting cavity. The outer side filter element is disposed in the mounting cavity. The inner side filter element includes a high efficiency particulate air (HEPA) layer and an activated carbon layer, and the inner side filter element is disposed on a radial inner side of the outer side filter element. The outer side filter element can be separately detached.

In some embodiments, the outer housing assembly includes a support, a cover shell and a cover plate. Two ends of the support are disposed open. The cover shell is detachably disposed on the support, and the cover shell is provided with a plurality of air inlet holes. The cover plate is detachably mounted on a bottom end of the support.

In some specific embodiments, a plurality of outer side filter elements are provided, the plurality of outer side filter elements are distributed in a circumferential direction of the support, and each of the plurality of outer side filter elements is detachably connected to the support.

In some specific embodiments, an inner side wall of the support is provided with a limit flanging extending in a height direction of the support, the limit flanging and the inner side wall of the support define a limit groove, and the outer side filter element is mounted in the limit groove.

In some specific embodiments, the support is provided with a plurality of mounting grooves spaced apart in a circumferential direction of the support, and each of the plurality of mounting grooves is provided with a cover shell.

In some more specific embodiments, a side wall of each of the plurality of mounting grooves is provided with a plurality of snap-fit grooves spaced apart in a height direction of the support, and each of the cover shells is provided with a plurality of snap-fit hooks for being mated with the plurality of snap-fit grooves.

In some specific embodiments, the cover plate is provided with a plurality of snap-fit protrusions spaced apart in a circumferential direction of the cover plate, the support is provided with a plurality of snap-fit grooves spaced apart in a circumferential direction of the support, and when the cover plate is rotated relative to the support, each of the plurality of snap-fit protrusions is capable of snapping into or being disengaged from a respective one of the plurality of snap-fit grooves.

In some more specific embodiments, a side wall of each of the plurality of snap-fit grooves is provided with a limit convex rib, each of the plurality of snap-fit protrusions is provided with a limit convex hull corresponding to the limit convex rib, and when the cover plate is rotated relative to the support, the limit convex hull is able to pass over the limit convex rib.

In some embodiments, a bottom wall of the cover plate is provided with a rotating handle and a plurality of anti-slip strips disposed around the rotating handle.

In some embodiments, the outer side filter element is detachably disposed on the inner side filter element.

### BRIEF DESCRIPTION OF DRAWINGS

FIG. 1 is a schematic structural view of an air purifier according to an embodiment of the present disclosure;

FIG. 2 is a schematic structural view of an air purifier whose fan assembly is detached according to an embodiment of the present disclosure;

FIG. 3 is a schematic view of the structure shown in FIG. 2 from another direction;

FIG. 4 is an exploded view of the structure shown in FIG. 2;

FIG. 5 is a sectional view of the structure shown in FIG. 2; and

FIG. 6 is another sectional view of the structure shown in FIG. 2.

### REFERENCE LIST

1 outer housing assembly

11 support

111 limit flanging

112 limit groove

113 mounting groove

114 snap-fit groove

115 snap-fit groove

116 limit convex rib

12 cover shell

121 air inlet hole

122 snap-fit hook

13 cover plate

131 snap-fit protrusion

132 limit convex hull

133 rotating handle

134 anti-slip strip

2 outer side filter element

3 inner side filter element

4 fan assembly

### DETAILED DESCRIPTION

To better illustrate the solved problem, adopted solutions and achieved effects of the present disclosure, the present disclosure is further described in conjunction with drawings and embodiments.

In the description of the present disclosure, it is to be understood that orientations or position relations indicated by terms such as “center”, “longitudinal”, “transverse”, “length”, “width”, “thickness”, “above”, “below”, “front”, “back”, “left”, “right”, “vertical”, “horizontal”, “top”, “bottom”, “inside”, “outside”, “clockwise”, “counterclockwise”, “axial”, “radial”, and “circumferential”, are based on orientations or position relations shown in the drawings. These orientations or position relations are intended only to facilitate the description of the present disclosure and simplify the description and not to indicate or imply that an apparatus or element referred to must have such specific orientations or must be configured or operated in such specific orientations. Thus, these orientations or position relations are not to be construed as limiting the present disclosure.

In addition, a feature defined as a “first” feature or a “second” feature may explicitly or implicitly include one or more of such features to distinguish and describe the features regardless of order or weight. In the description of the present disclosure, unless otherwise noted, “a plurality of” means two or more.

In the description of the present disclosure, it is to be noted that unless otherwise expressly specified and limited, the term “mounted”, “connected to each other” or “connected” should be construed in a broad sense as securely connected, detachably connected or integrally connected; mechanically connected or electrically connected; directly connected to each other or indirectly connected to each other via an intermediary; or intraconnected between two elements. For those of ordinary skill in the art, specific meanings of the above terms in the present disclosure may be understood according to specific conditions.

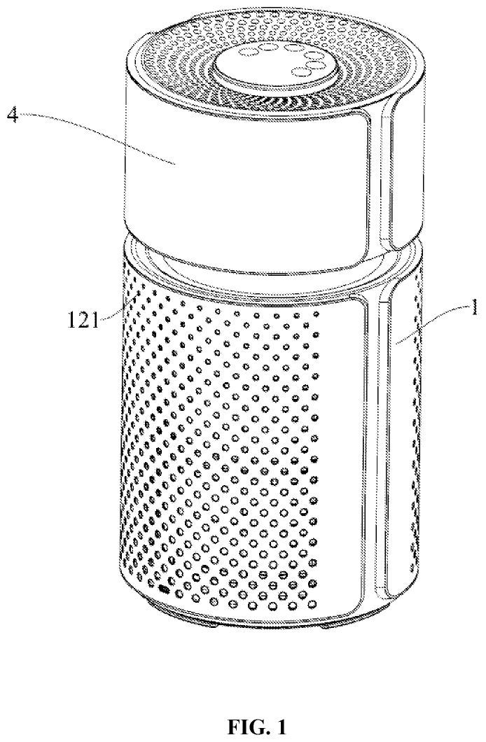

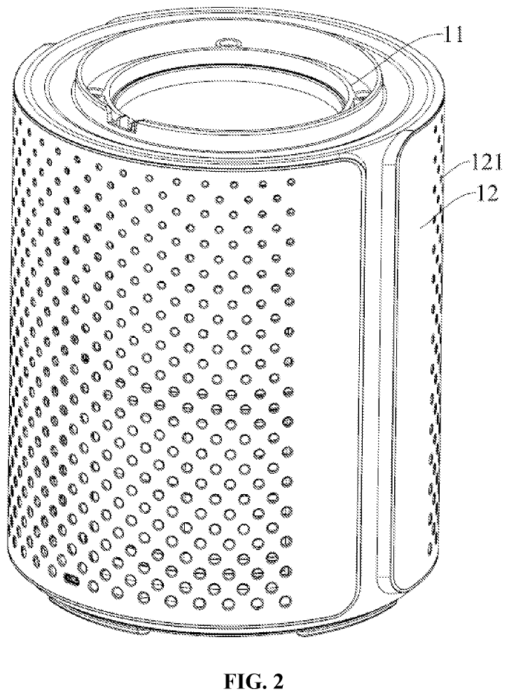

The specific structure of the air purifier of an embodiment of the present disclosure is described with reference to FIGS. 1 to 6.

The present disclosure discloses an air purifier. As shown in FIGS. 1 to 6, the air purifier includes an outer housing assembly 1, an outer side filter element 2 and an inner side filter element 3. The outer housing assembly 1 defines a mounting cavity, and the outer housing assembly 1 is provided with air inlet holes 121 communicated with the mounting cavity. The outer side filter element 2 is disposed in the mounting cavity. The inner side filter element 3 includes a high efficiency particulate air (HEPA) layer and an activated carbon layer, and the inner side filter element 3 is disposed on a radial inner side of the outer side filter element 2. The outer side filter element 2 can be separately detached.

It is to be understood that in the embodiment, after a period of use of the air purifier, relatively more large-particle dirt accumulates on the outer side filter element 2, and the outer side filter element 2 is directly detached and cleaned. The outer side filter element 2 can be separately detached relative to the inner side filter element 3, so that the manner of integrally replacing a filter module in the related art is avoided, and the cost of the air purifier is reduced. Moreover, the case where the inner side filter element 3 is damaged due to the cleaning of the outer side filter element 2 is avoided, and thus the filtering effect of the inner side filter element 3 is ensured. On the other hand, it is avoided that the noise of the air purifier is increased and the filtering effect is reduced caused by the large-particle dirt rubbed into the inner side filter element 3 due to the fact that the outer side filter element 2 cannot be detached and thus needs to be scrubbed by a wiping cloth. Therefore, the noise caused in the use process of the air purifier is further reduced since the outer side filter element 2 is separately detached relative to the inner side filter element 3.

It is to be additionally noted that in the present disclosure, the HEPA layer and the activated carbon layer may be an integral sheet packaged together or two sheets detachably connected, which may be specifically selected according to practical requirements.

It is to be additionally noted that in the embodiment of the present disclosure, the outer side filter element 2 may be detached through various manners. For example, in some embodiments, the outer side filter element 2 and the inner side filter element 3 are both detachably disposed on the outer housing assembly 1; in some embodiments, the outer side filter element 2 is detachably connected to the inner side filter element 3, and the inner side filter element 3 is detachably connected to the outer housing assembly 1; in some embodiments, the outer side filter element 2 is detachably connected to the inner side filter element 3, and the inner side filter element 3 is fixedly connected to the outer housing assembly 1. That is, the mounting manner of the outer side filter element 2 and the mounting manner of the inner side filter element 3 may be selected according to practical requirements.

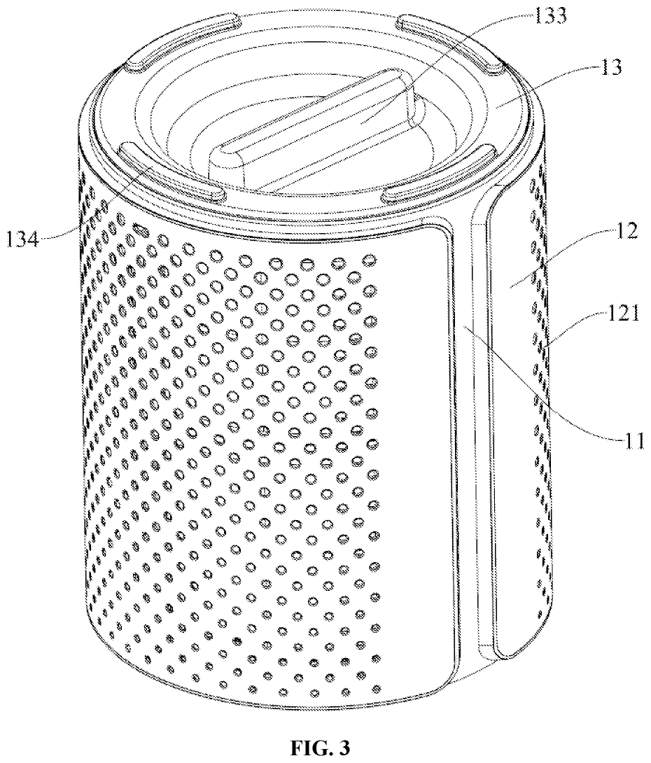

In some embodiments, as shown in FIG. 3, the outer housing assembly 1 includes a support 11, a cover shell 12 and a cover plate 13. Two ends of the support 11 are disposed open.

The cover shell 12 is detachably disposed on the support 11, and the cover shell 12 is provided with multiple air inlet holes 121. The cover plate 13 is detachably mounted on a bottom end of the support 11. It is to be understood that one end of the support 11 needs to be connected to a fan assembly 4 of the air purifier. Since the two ends of the support 11 are disposed open, during the mounting process, the fan assembly 4 may be mounted from one side of the support 11, the outer side filter element 2 and the inner side filter element 3 may be mounted from the other side of the support 11, so that the mounting of the fan assembly 4, the mounting of the outer side filter element 2 and the mounting of the inner side filter element 3 do not affect each other. Therefore, the assembly of the entire air purifier is facilitated, and the efficiency of producing the air purifier is improved. In addition, in the long-term use process, the air inlet holes 121 may be blocked and need to be cleaned. In the embodiment, the air inlet holes 121 are provided on the cover shell 12 detachably connected to the support 11, so that it is convenient for a user to clean the air inlet holes 121, and stable air intake of the air purifier of the embodiment is ensured.

It is to be additionally noted that the air inlet holes 121 on the cover shell 12 may be arranged in multiple rows and multiple columns, or may be radially distributed, and the air inlet holes 121 may be round holes or square holes. In the embodiment of the disclosure, the shape, the number, the size and the distribution manner of the air inlet holes 121 may be selected according to actual requirements, and the specific structure, the number, the size and the distribution manner of the air inlet holes 121 are not specifically limited herein.

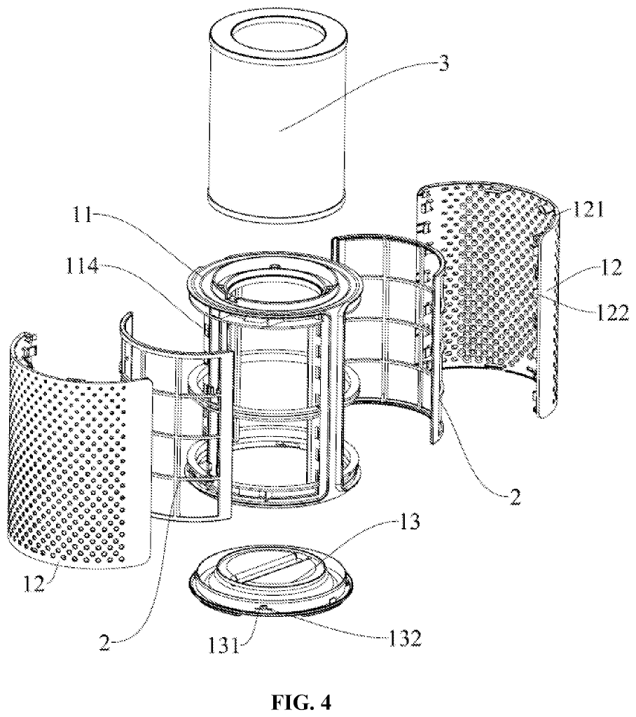

In some specific embodiments, as shown in FIG. 4, multiple outer side filter elements 2 are provided. The multiple outer side filter elements 2 are distributed in a circumferential direction of the support 11, and each outer side filter element 2 is detachably connected to the support 11. It is to be understood that the outer side filter element 2 is divided into multiple side filter elements in a circumferential direction of the support 11, so that the mounting and detaching of the outer side filter elements 2 are facilitated, and it is convenient for the user to mount and clean the outer side filter elements 2.

It is to be additionally noted that the shapes of the outer side filter elements 2 may be selected according to the shape of the support 11. For example, if the support 11 is of a cylindrical structure, each outer side filter element 2 is of an arc-shaped structure, and if the support 11 is of a cubic structure, each outer side filter element 2 is of a flat plate structure.

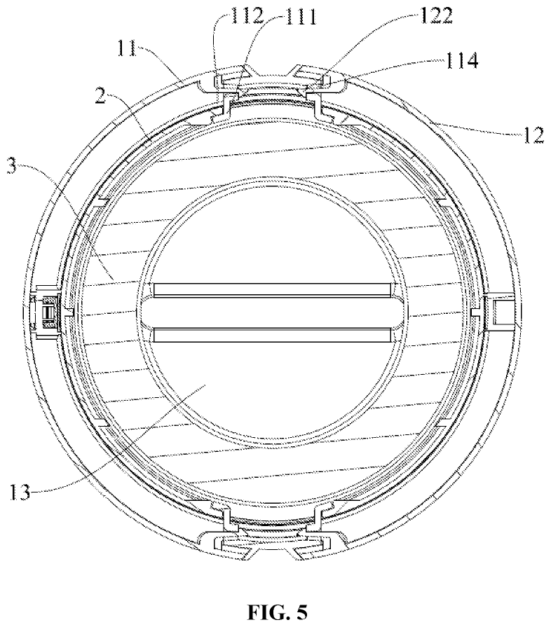

In some specific embodiments, as shown in FIG. 5, an inner side wall of the support 11 is provided with a limit flanging 111 extending in a height direction of the support 11, the limit flanging 111 and the inner side wall of the support 11 define a limit groove 112, and the outer side filter element 2 is mounted in the limit groove 112. It is to be noted that since the inner side wall of the support 11 is provided with the limit flanging 111 extending in the height direction of the support 11, in the practical mounting process, the outer side filter element 2 may be inserted into the limit groove 112 in the height direction of the support 11, so that not only can the mounting stability of the outer side filter element 2 be ensured, but a connector between the outer side filter element 2 and the support 11 can also be omitted, which is convenient for the user to mount and detach the outer side filter element 2.

It is to be additionally noted that the manner of the connection between the support 11 and the outer side filter element 2 is not limited to the structure of the outer side filter element 2 inserted into the limit groove 112 in the embodiment. For example, the support 11 may be mated with the outer side filter element 2 through a snap structure, or be connected to the outer side filter element 2 through screws, rivets or the like.

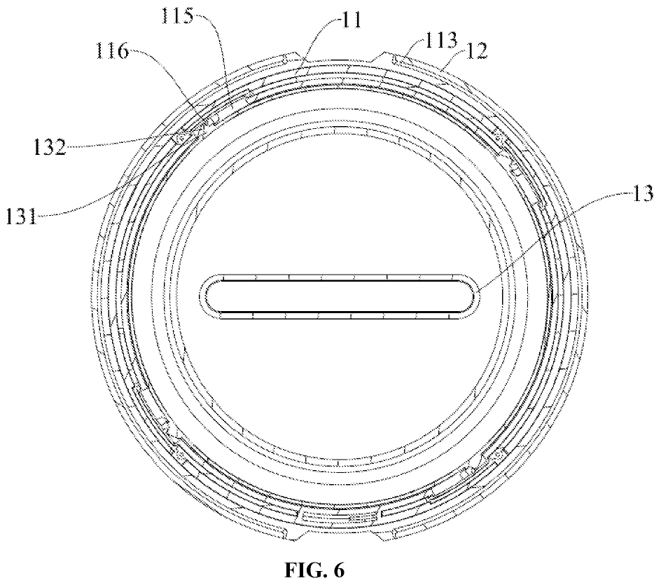

In some specific embodiments, as shown in FIG. 6, the support 11 is provided with multiple mounting grooves 113 spaced apart in a circumferential direction of the support 11, and each mounting groove 113 is provided with a cover shell 12. It is to be understood that the cover shell 12 is divided into multiple cover shells in a circumferential direction of the support 11, so that the mounting and detaching of the cover shell 12 are facilitated, and it is convenient for the user to mount and clean the cover shell 12. It is to be additionally noted that the shapes of the cover shells 12 may be selected according to the shape of the support 11. For example, if the support 11 is of a cylindrical structure, each cover shell 12 is of an arc-shaped structure, and if the support 11 is of a cubic structure, each cover shell 12 is of a flat plate structure.

In some more specific embodiments, as shown in FIG. 5, a side wall of each mounting groove 113 is provided with multiple snap-fit grooves 114 spaced apart in a height direction of the support 11, and each cover shell 12 is provided with multiple snap-fit hooks 122 for being mated with the multiple snap-fit grooves 114. The use of the snap-fit hooks 122 and the snap-fit grooves 114 not only ensures the stability of the connection between the cover shell 12 and the support 11, but also omits a connector between the cover shell 12 and the support 11. Therefore, it is convenient for the user to mount and detach the cover shell 12. The connection between the support 11 and the cover shell 2 is not limited to the snap of the snap-fit hooks 2 into the snap-fit grooves 112 in the embodiment. For example, the support 11 may be connected to the cover shell 12 through screws, rivets or the like. The manner of the connection between the support 11 and the cover shell 12 may be selected according to practical requirements.

In some specific embodiments, as shown in FIG. 6, the cover plate 13 is provided with multiple snap-fit protrusions 131 spaced apart in a circumferential direction of the cover plate 13, the support 11 is provided with multiple snap-fit grooves 115 spaced apart in a circumferential direction of the support 11, and in a case where the cover plate 13 is rotated relative to the support 11, each snap-fit protrusion 131 can snap into or be disengaged from a respective snap-fit groove 115. It is to be understood that after the outer side filter element 2 and the inner side filter element 3 are mounted, the connection between the cover plate 13 and the support 11 can be completed only by rotating the cover plate 13 to enable the snap-fit protrusions 131 to snap into the snap-fit grooves 115, so that the operation of the user is simplified, and it is convenient for the user to mount and detach the cover plate 13, the inner side filter element 3 and the outer side filter element 2.

In some more specific embodiments, as shown in FIG. 6, a side wall of each snap-fit groove 115 is provided with a limit convex rib 116, each snap-fit protrusion 131 is provided with a limit convex hull 132 corresponding to the respective limit convex rib 116, and when the cover plate 13 is rotated relative to the support 11, the limit convex hull 132 can pass over the respective limit convex rib 116. It is to be understood that when the cover plate 13 is rotated, after the limit convex hull 132 passes over the limit convex rib 116, the limit convex rib 116 can achieve the effect of limiting the limit convex hull 132, so that the case where the snap-fit protrusions 131 are disengaged from the snap-fit grooves 115 due to shaking of the cover plate 13 is avoided, and the stability of the connection between the cover plate 13 and the support 11 is ensured.

It is to be additionally noted that the manner of the connection between the cover plate 13 and the support 11 may be selected according to practical requirements, and is not limited to the manner of the connection between the snap-fit protrusions 131 and the snap-fit grooves 115 in the embodiment. For example, the cover plate 13 may be connected to the support 11 through screws, rivets or other connectors.

In some embodiments, as shown in FIG. 5, a bottom wall of the cover plate 13 is provided with a rotating handle 133 and multiple anti-slip strips 134 disposed around the rotating handle 133. It is to be understood that the rotating handle 133 facilitates the rotating of the cover plate 13 by the user and thereby facilitates the mounting and detaching of the cover plate 13 by the user. The anti-slip strips 134 can keep the entire air purifier to be stable and achieve the shock absorption and anti-slip effects.

In some embodiments, the outer side filter element 2 is detachably disposed on the inner side filter element 3. Therefore, after long-term use, the outer side filter element 2 can be conveniently detached and cleaned, so that the case where the inner side filter element 3 is damaged due to the cleaning of the outer side filter element 2 is avoided.

In the embodiment of the disclosure, an outer side wall of the inner side filter element 3 is provided with a guide groove, and an inner side wall of the outer side filter element 2 is provided with a guide protrusion mated in the guide groove so as to achieve the sliding mounting of the inner side filter element 3 and the outer side filter element 2. The inner side filter element 3 and the outer side filter element 2 may also be mounted through connectors such as screws and rivets. That is, in other embodiments of the present disclosure, the manner of the connection between the inner side filter element 3 and the outer side filter element 2 can be selected according to practical requirements.

Embodiment

The structure of the air purifier of a specific embodiment of the present disclosure is described with reference to FIGS. 1 to 6.

As shown in FIGS. 1 to 6, the air purifier of the embodiment includes an outer housing assembly 1, outer side filter elements 2, an inner side filter element 3 and a fan assembly 4. The outer housing assembly 1 defines a mounting cavity, and the outer housing assembly 1 includes a support 11, cover shells 12 and a cover plate 13.

Two ends of the support 11 are disposed open. The support 11 is provided with mounting grooves 113, limit flangings 111 and snap-fit grooves 115. Two mounting grooves 113 are disposed spaced apart in a circumferential direction of the support 11, and a side wall of each mounting groove 113 is provided with multiple snap-fit grooves 114 spaced apart in a height direction of the support 11. Four snap-fit grooves 115 are disposed spaced apart in the circumferential direction of the support 11. Two flangings 111 are provided, and each limiting flange 111 extends in the height direction of the support 11 and defines a limit groove 112 with an inner side wall of the support 11. Two cover shell 12 are provided, and each cover shell 12 is fitted in one mounting groove 113 and is provided with multiple snap-fit hooks 122 for being mated with the multiple snap-fit grooves 114. In addition, each cover shell 12 is further provided with multiple air inlet holes 121 arranged in rows and columns. The cover plate 13 is provided with four snap-fit protrusions 131 spaced apart in a circumferential direction of the cover plate 13, and each snap-fit protrusion 131 can be mated in one snap-fit groove 115. A side wall of each snap-fit groove 15 is provided with a limit convex rib 116, each snap-fit protrusion 131 is provided with a limit convex hull 132 corresponding to the respective limit convex rib 116, and when the cover plate 13 is rotated relative to the support 11, the limit convex hull 132 can pass over the limit convex rib 116. The fan assembly 4 is detachably mounted on a top end of the support 11. Two outer side filter elements 2 are provided and distributed in the circumferential direction of the support 11 in one-to-one correspondence to the two cover shells 12, and each outer side filter element 2 is mounted in one limit groove 112. The inner side filter element 3 includes a HEPA layer and an activated carbon layer, and the inner side filter element 3 is disposed on a radial inner side of the outer side filter elements 2.

The air purifier of the embodiment has the advantages described below.

Firstly, the outer side filter elements 2 can be separately detached relative to the inner side filter element 3, so that the manner of integrally replacing a filter module in the related art is avoided, and the cost of the air purifier is reduced. Moreover, the that the case where the inner side filter element 3 is damaged due to the cleaning of the outer side filter elements 2 is avoided, and thus the filtering effect of the inner side filter element 3 is ensured.

Secondly, the air inlet holes 121 are provided on the cover shells 12, and the cover shells 12 are detachably mated on the support 11, so that it is convenient for a user to clean the air inlet holes 121, and stable air intake of the air purifier is ensured.

Thirdly, the support 11 is mated with the cover shells 12 through the snap-fit grooves 114 and the snap-fit hooks 122, and the support 11 is mated with the outer side filter elements 2 through the limit grooves 112, so that connectors for the connection between the support 11 and the cover shells 12 and the connection between the support 11 and the outer side filter elements 2 are omitted, and the mounting efficiency is improved.

Fourthly, a bottom of the support 11 is provided with a rotatably connected cover plate 13. The fan assembly 4 may be mounted from one side of the support 11, and the outer side filter elements 2 and the inner side filter element 3 may be mounted from the other side of the support 11, so that the mounting of the fan assembly 4, the mounting of the outer side filter elements 2 and the mounting of the inner side filter element 3 do not affect each other. Therefore, the assembly of the entire air purifier is facilitated, and the efficiency of producing the air purifier is improved.

In the description of the Specification, the description of reference terms such as “some embodiments” and “other embodiments” is intended to mean that specific features, structures, materials, or characteristics described in conjunction with such embodiments or examples are included in at least one embodiment or example of the present disclosure. In the

Specification, the illustrative description of the preceding terms does not necessarily refer to the same embodiment or example. Moreover, the described specific features, structures, materials or characteristics may be combined in an appropriate manner in any one or more embodiments or examples.

The above are merely preferred embodiments of the present disclosure. Those of ordinary skill in the art will make modifications in the specific embodiments and application scope according to the present disclosure. The content of the Specification is not to be construed as limiting the present disclosure.

What is claimed is:

1. An air purifier, comprising:
an outer housing assembly, which defines a mounting cavity and is provided with air inlet holes communicated with the mounting cavity;
an outer side filter element, which is disposed in the mounting cavity; and
an inner side filter element, which comprises a high efficiency particulate air (HEPA) layer and an activated carbon layer and is disposed on a radial inner side of the outer side filter element, wherein the outer side filter element is separately detachable.

2. The air purifier according to claim 1, wherein the outer housing assembly comprises:
a support, two ends of which are disposed open;
a cover shell, which is detachably disposed on the support and is provided with a plurality of air inlet holes; and
a cover plate, which is detachably mounted on a bottom end of the support.

3. The air purifier according to claim 2, wherein a plurality of outer side filter elements are provided, the plurality of outer side filter elements are distributed in a circumferential direction of the support, and each of the plurality of outer side filter elements is detachably connected to the support.

4. The air purifier according to claim 2, wherein an inner side wall of the support is provided with a limit flanging extending in a height direction of the support, the limit flanging and the inner side wall of the support define a limit groove, and the outer side filter element is mounted in the limit groove.

5. The air purifier according to claim 2, wherein a plurality of cover shells are provided, the support is provided with a plurality of mounting grooves spaced apart in a circumferential direction of the support, and each of the plurality of mounting grooves is provided with a respective one of the plurality of cover shells.

6. The air purifier according to claim 5, wherein a side wall of the each of the plurality of mounting grooves is provided with a plurality of snap-fit grooves spaced apart in a height direction of the support, and the respective one of the plurality of cover shells is provided with a plurality of snap-fit hooks for being mated with the plurality of snap-fit grooves.

7. The air purifier according to claim 2, wherein the cover plate is provided with a plurality of snap-fit protrusions spaced apart in a circumferential direction of the cover plate, the support is provided with a plurality of snap-fit grooves spaced apart in a circumferential direction of the support, and when the cover plate is rotated relative to the support, each of the plurality of snap-fit protrusions is capable of snapping into or being disengaged from a respective one of the plurality of snap-fit grooves.

8. The air purifier according to claim 7, wherein a side wall of each of the plurality of snap-fit grooves is provided with a limit convex rib, each of the plurality of snap-fit protrusions is provided with a limit convex hull corresponding to a respective one of the limit convex ribs, and when the cover plate is rotated relative to the support, the limit convex hull is able to pass over the limit convex rib.

9. The air purifier according to claim 2, wherein a bottom wall of the cover plate is provided with a rotating handle and a plurality of anti-slip strips disposed around the rotating handle.

10. The air purifier according to claim 1, wherein the outer side filter element is detachably disposed on the inner side filter element.
